(19) United States
(12) Patent Application Publication
(10) Pub. No.: US 2023/0291061 A1
(43) Pub. Date: Sep. 14, 2023

(54) BATTERY ASSEMBLIES COMPRISING LITHIUM-METAL ELECTROCHEMICAL CELLS AND PRESSURE-APPLYING STRUCTURES

(71) Applicant: Cuberg, Inc., San Leandro, CA (US)

(72) Inventors: Seamus Bannon, Oakland, CA (US); Nadine Kuhn, Boston, MA (US); Edward Meyjes, Berkeley, CA (US); Stephen Lawes, Oakland, CA (US); Richard Wang, Danville, CA (US); Chan Lojewski, Pleasanton, CA (US)

(73) Assignee: Cuberg, Inc., San Leandro, CA (US)

(21) Appl. No.: 17/654,016

(22) Filed: Mar. 8, 2022

(51) Int. Cl. H01M 50/293; H01M 50/209; H01M 50/211; H01M 10/0525

(52) U.S. Cl. CPC H01M 50/293; H01M 50/209; H01M 50/211; H01M 10/0525

(57) ABSTRACT

Described herein are battery assemblies that comprise lithium-metal electrochemical cells and pressure-applying structures disposed adjacent to the cells and applying uniform pressure to the cells. Specifically, this uniform pressure is applied between a minimum threshold and a maximum threshold at any operating state of charge of these cells and, in some examples, over the entire operating lifetime of the cells. A pressure-applying structure can be positioned between a pair of adjacent cells or between a cell and an assembly enclosure. In some examples, the footprint of the pressure-inducing structure fully covers the footprint of the negative-electrode planar portion. The pressure-inducing structure may have a stress relaxation of less than 5% and/or a compression set of less than 10%. The pressure-inducing structure may remain in an elastic deformation region at any operating condition. In some examples, the pressure-inducing structure is foam or aerogel.

### BACKGROUND

Lithium-ion (Li-ion or Lil) cells or, more generally, Li-ion batteries are widely used for various applications. For example, Li-ion batteries are used to power devices as small as medical devices or cell phones and as large as electric vehicles or aircraft. The wide adoption of Li-ion batteries across many industries resulted in many useful designs and knowledge about fabricating Li-ion battery modules and packs. In particular, many concerns involving cycling efficiency, capacity, and safety have been addressed in Li-ion batteries.

Lithium metal (Li-metal or LiM) cells represent a different battery type and are distinct from Li-ion cells. Specifically, Li-ion cells utilize special negative-electrode active materials (e.g., graphite, silicon) to trap lithium ions when the Li-ion cells are charging. On the other hand, Li-metal cells utilize the direct deposition (e.g., plating) of lithium metal on the negative current collectors without a need for any additional active materials for trapping lithium ions. As such, Li-metal cells tend to have a lower weight and a higher energy density in comparison to Li-ion cells. For example, Li-metal has a specific capacity of 3,860 mAh/g, which is about ten times higher than that of graphite.

However, Li-metal cells or, more generally, Li-metal batteries are currently not widely adopted at the scale of Li-ion batteries for various reasons. For example, Li-metal cells form large lithium-metal aggregates on negative electrodes when the cells are being charged. As a result of these lithium-metal aggregates, Li-metal cells tend to change in size during each cycle. Various characteristics (e.g., porosity, morphology) of these lithium-metal aggregates depend, at least in part, on the pressure applied to the cells and, more specifically, on the pressure applied to the negative electrodes. Furthermore, Li-metal cells tend to swell as these cells continue cycling, i.e., over the course of charge/discharge cycles.

What is needed are new methods and devices of controlling the external pressure applied to lithium-metal electrochemical cells.

### SUMMARY

Described herein are battery assemblies that comprise lithium-metal electrochemical cells and pressure-applying structures disposed adjacent to the cells and applying uniform pressure to the cells. The lithium-metal electrochemical cells are formed with a liquid electrolyte, which can comprise ionic liquid. Specifically, this uniform pressure is applied between a minimum threshold and a maximum threshold at any operating state of charge of these cells and, in some examples, over the entire operating lifetime of the cells. A pressure-applying structure can be positioned between a pair of adjacent cells and/or between a cell and an assembly enclosure. In some examples, the footprint of the pressure-inducing structure fully covers at least the footprint of the negative-electrode planar portion. The pressure-inducing structure may remain in an elastic deformation region at any operating condition. Some examples of the pressure-inducing structure include foam or aerogel.

In some examples, a battery assembly comprises a lithium-metal electrochemical cell comprising a liquid electrolyte and a pressure-applying structure, positioned adjacent to the lithium-metal electrochemical cell and applying uniform pressure between a set minimum threshold and a set maximum threshold to the lithium-metal electrochemical cell at any operating state of charge of the lithium-metal electrochemical cell.

In some examples, the battery assembly further comprises an additional lithium-metal electrochemical cell. The pressure-applying structure is disposed between the lithium-metal electrochemical cell and the additional lithium-metal electrochemical cell and applies the uniform pressure to the lithium-metal electrochemical cell and to the additional lithium-metal electrochemical cell. In some examples, the battery assembly further comprises an assembly enclosure, wherein the pressure-applying structure is disposed between the lithium-metal electrochemical cell and the assembly enclosure.

In some examples, the set minimum threshold is between 200 kPa and 400 kPa. In the same or other examples, the set maximum threshold is between 600 kPa and 1,000 kPa.

In some examples, the lithium-metal electrochemical cell is a pouch cell or a prismatic cell. For example, the lithium-metal electrochemical cell comprises electrodes, each having a planar portion. The footprint of the pressure-inducing structure fully covers the footprint of the planar portion.

In some examples, the pressure-inducing structure directly interfaces the lithium-metal electrochemical cell. In the same or other examples, at least a portion of the pressure-inducing structure remains in an elastic deformation region at any state of charge of the lithium-metal electrochemical cell.

In some examples, at least a portion of the pressure-inducing structure has a thermal conductivity of less than 0.2 W/mK. In the same or other examples, the pressure-inducing structure has a density of less than 1.5 g/cm³ while applying the uniform pressure at the set maximum threshold on the lithium-metal electrochemical cell.

In some examples, at least a portion of the pressure-inducing structure is foam or aerogel. For example, the foam of the pressure-inducing structure comprises one or more of polyethylene, polypropylene, polystyrene, polyurethane, polysiloxane, neoprene, polytetrafluoroethylene, poly(methyl methacrylate), polyacrylate, polyimide, flame-resistant rubber, and foam ceramic. In some examples, the pressure-inducing structure comprises a non-porous polysiloxane. For example, the pressure-inducing structure has a porosity of less than 10%.

In some examples, the pressure-inducing structure comprises one or a carbon-containing composite and a carbon-based material. For example, the pressure-inducing structure comprises a carbon-fiber-reinforced polymer. In some examples, at least a portion of the pressure-inducing structure comprises a material with a temperature resistance of at least 2000° C.

In some examples, the pressure-inducing structure is a composite structure comprising a heat-blocking component and a pressurizing component. The heat-blocking component has a thermal conductivity of less than 0.2 W/mK. The pressurizing component remains in an elastic deformation region at any state of charge of either the lithium-metal electrochemical cell or the additional lithium-metal electrochemical cell.

In some examples, the pressure-inducing structure applies the uniform pressure between the set minimum threshold and the set minimum threshold on the lithium-metal electrochemical cell over an operating lifetime of the battery assembly.

These and other embodiments are described further below with reference to the figures.

### BRIEF DESCRIPTION OF THE DRAWINGS

FIG. 1A is a schematic cross-sectional view of a lithium-metal electrochemical cell in a discharged state.

FIG. 1B is a schematic cross-sectional view of the lithium-metal electrochemical cell of FIG. 1A that is now in a charged state, illustrating the charge in the negative electrode thickness and the total cell thickness.

FIG. 1C is a plot of the cell thickness as a function of the cycle life, illustrating the increase in the cell thickness over time.

FIG. 2A is a schematic cross-sectional view of a battery assembly illustrating a pressure-applying structure positioned between two lithium-metal electrochemical cells, in accordance with some examples.

FIG. 2B is a schematic cross-sectional view of a battery assembly illustrating pressure-applying structures positioned between the assembly enclosure and each lithium-metal electrochemical cell, in accordance with some examples.

FIG. 2C is a schematic cross-sectional view of a battery assembly illustrating a pressure-applying structure positioned between two lithium-metal electrochemical cells while two additional lithium-metal electrochemical cells do not have direct contact with the pressure-applying structure, in accordance with some examples.

FIG. 2D is a schematic cross-sectional view of a battery assembly illustrating a pressure-applying structure positioned between the assembly enclosure and the lithium-metal electrochemical cell, in accordance with some examples.

FIG. 2E is a plot of the pressure exerted by a pressure-applying structure as a function of the compressive strain.

FIG. 3A is a top view of an assembly enclosure forming a band around lithium-metal electrochemical cells with pressure-relieving devices positioned between the cells, in accordance with some examples.

FIG. 3B is a schematic illustration of the operation of a pressure-relieving device used in an assembly enclosure, in accordance with some examples.

FIGS. 4A and 4B is a schematic cross-sectional view of a battery assembly illustrating a pressure-applying structure, comprising a heat-blocking component and a pressurizing component, in accordance with some examples.

FIG. 5 is a block diagram of an electric vehicle comprising a battery assembly with a pressure-applying structure and a lithium-metal electrochemical cell, in accordance with some examples.

FIG. 6A illustrates cycle-life plots for cells that were cycled while different external pressures were applied to these cells.

FIG. 6B illustrates cycle-life plots for cells using different materials for pressure-applying structures while the same external pressure was applied to these cells.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### Introduction

Li-metal cells provide significant capacity improvements over conventional Li-ions cells. Furthermore, Li-metal cells with liquid electrolytes, which may be referred to as liquid-based Li-metal cells, enable high-rate capabilities in comparison to solid-state Li-metal cells. However, liquid-based Li-metal cells have a higher chance of forming dendrites due to the relatively unconstrained lithium-metal layer on the negative electrode and the constant plating and stripping of lithium metal on the negative electrodes. Furthermore, Li-metal cells can experience an increase in cell impedance due to the formation of a porous lithium layer. Specifically, the increase in porosity will cause a more tortuous path for lithium-ions within the cell, increasing lithium-ion mean free path length thereby causing the cell impedance to increase. This phenomenon is unique to Li-metal cells because charging these cells involves an electroplating process of a lithium layer on the negative electrode. This plating is repeated every time a Li-metal cell is charged. For comparison, lithium in Li-ion cells undergoes an intercalation process when captured and trapped by graphite of the negative electrode.

When external pressure is applied to a Li-metal cell, lithium plating is more uniform thereby reducing the dendrite growth and minimizing the porosity of the plated lithium layer. Without being restricted to any particular theory, it is believed that these improvements are caused by the high ductility of metallic lithium. In other words, a combination of external pressure and high ductility mechanically suppresses non-uniformities in a plated lithium layer. In other words, plated lithium is redistributed while being plated and after plating resulting in a more uniform final Li-metal layer. This external pressure needs to be maintained between the minimum and maximum thresholds. In other words, the external pressure needs to be sufficiently high to effectively control the uniform distribution of lithium, e.g., be above the yield strength. On the other hand, high external pressures can cause internal shorts. For example, excessive pressure can damage internal components of liquid-based Li-metal cells, such as polymer separators positioned between negative and positive electrodes. Furthermore, high pressures require complex components and systems to support these pressures.

It should be noted that solid-state Li-metal cells, which are Li-metal cells with solid electrolytes (e.g., ceramic electrolytes, polymer electrolytes), may also use external pressure. However, solid-state Li-metal cells require much higher external pressure levels than liquid-electrolyte based Li-metal cells. The purpose of external pressure in solid-state Li-metal cells is to increase the contact and adhesion of the solid electrolytes and electrodes, which is not a concern in liquid-electrolyte based Li-metal cells. For example, solid-state Li-metal cells use pressures often exceeding 3-5 MPa. It should be noted that generating such pressures require special systems, which can be complex and/or heavy.

In another example, Li-ion pouch cells can be pressurized (e.g., up to 20-30 kPa) to improve lithium-ion diffusion between electrodes. Higher pressure levels do not produce any further diffusion improvements and, therefore, are not used. Furthermore, Li-ion pouch cells use external pressure to accommodate swelling associated with some high-capacity active materials, such as silicon. Again, the pressure levels for these applications are substantially less (e.g., up to 150 kPa) than is needed for Li-metal cells.

One challenge associated with maintaining a controlled pressure on Li-metal cells is the expansion and contraction of these cells during each cycling and more general as well as the gradual expansion over the operating lifetime. The first type of expansion and contraction depends on the state of charge (SOC) of the cell and can be referred to as SOC-based thickness change. The second type of expansion depends on the state of health (SOH) of the cell and can be referred to as SOH-based swelling. In some examples, the thickness of a Li-metal cell increases as much as 20% by end of life, in comparison to the initial cell thickness.

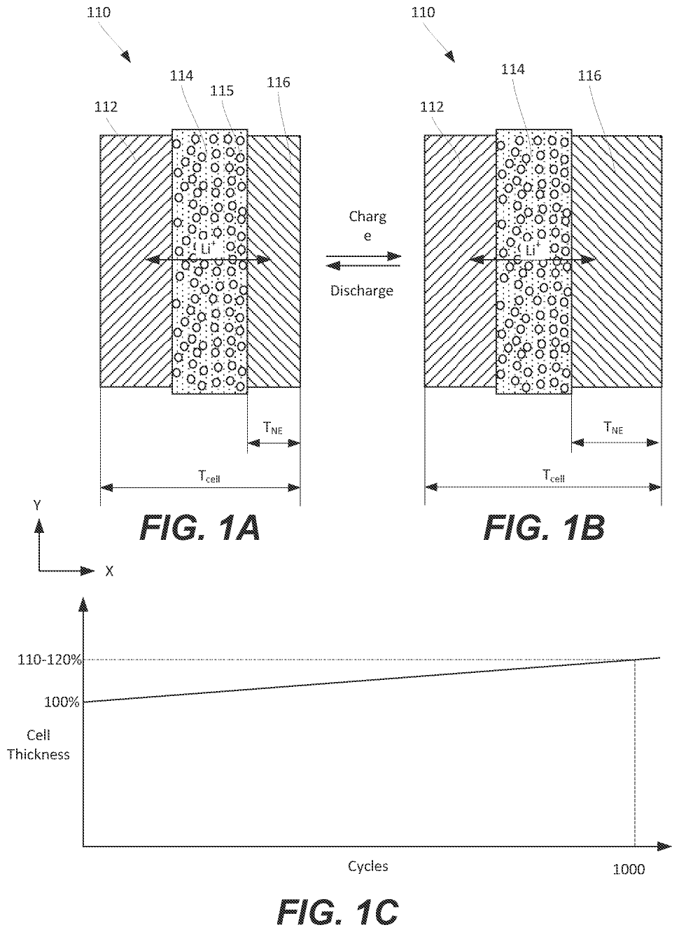

Specifically, FIG. 1A is a schematic illustration of lithium-metal electrochemical cell 110 in a discharged state, while FIG. 1B is a schematic illustration of the same lithium-metal electrochemical cell 110 in a charged state. Lithium-metal electrochemical cell 110 comprises positive electrode 112, negative electrode 116, and separator 114 positioned between positive electrode 112 and negative electrode 116. Separator 114 provides physical and electronic separation between positive electrode 112 and negative electrode 116. Furthermore, separator 114 is soaked with liquid electrolyte 115, which provides ionic transfer between positive electrode 112 and negative electrode 116. During the charge, lithium ions are transported from positive electrode 112 to negative electrode 116, where lithium ions are converted into metallic lithium. This metallic lithium is plated on a current collector causing the thickness of negative electrode 116 (T_{NE}) to increase in the direction perpendicular to the plane of the electrodes (e.g., the X-direction in FIGS. 1A and 1B). It should be noted that positive electrode 112 and separator 114 typically do not experience any major volume changes during the charge and discharge, in comparison to the volume changes of negative electrode 116. The thickness of negative electrode 116 causes lithium-metal electrochemical cell 110 to change its thickness (T_{CELL}) In some examples, the cell thickness can change by as much as 10% between a fully discharged state (the smallest thickness) and a fully charged state (the largest thickness). In other words, the cell's thickness depends on the cell's SOC and increases and decreases with the SOC. This SOC-based thickness change should be distinguished from the SOH-based swelling, which is irreversible and which will now be described with reference to FIG. 1C. Specifically, FIG. 1C illustrates a cell thickness profile as a function of an aggregate cycle number. As lithium-metal electrochemical cell 110 continues to cycle, the cell thickness (on average) continues to increase, e.g., up to 10%-20% over 1000 cycles. This SOH-based swelling is caused by the accumulation of porous and “dead” lithium over time. “Dead” lithium is no longer electrochemically accessible and does not contribute to the cell capacity. It should be noted that this SOH-based swelling is in addition to the SOC-based thickness change. In other words, a cumulative effect of the SOH-based swelling and the SOC-based thickness change needs to be accounted for when controlling the external pressure of lithium-metal electrochemical cell 110.

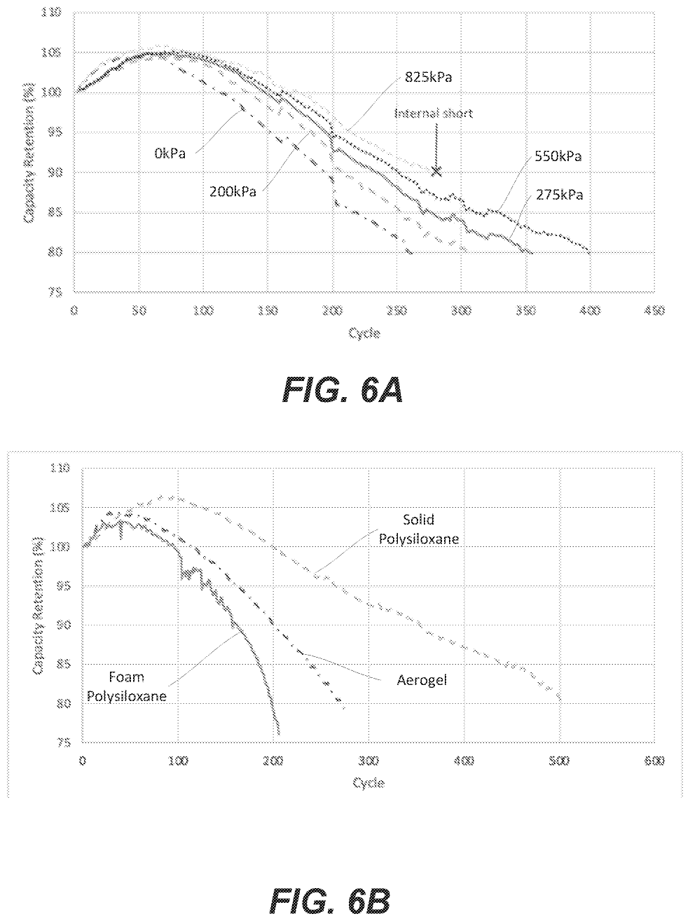

It has been found that subjecting Li-metal cells to a uniform and continuous pressure between set maximum and minimum thresholds helps with the uniform lithium deposition and reduces the internal resistance of the cells. The minimum pressure threshold is between 200 kPa and 400 kPa to achieve desired effects, e.g., the desired cycle life as described below with reference to FIG. 6. The minimum pressure threshold generally corresponds to the lithium metal ductility. In other words, the minimum pressure threshold should be such that at this threshold, some redistribution of lithium in the lithium plated layer can occur to ensure the uniformity of this plated layer. The maximum pressure threshold is between 600 kPa and 1,000 kPa. As noted above, higher pressure levels increase the cell's propensity for internal shorts and require special components and systems to support such pressure levels. Furthermore, higher pressure levels are generally not needed to achieve redistribution of lithium in the lithium plated layer as lithium has high ductility.

The pressure can be provided by a pressure-applying structure, positioned adjacent to a lithium-metal electrochemical cell. Specifically, a pressure-applying structure can be positioned in contact with a lithium-metal electrochemical cell (e.g., between two lithium-metal electrochemical cells or between a lithium-metal electrochemical cell and an assembly enclosure). Alternatively, a cell that is being pressurized by a pressure-applying structure is separated from the pressure-applying structure by another component, such as another lithium-metal electrochemical cell, a lithium-ejecta containment component, or the like. It should be noted that the construction of a lithium-metal electrochemical cell is such that the external pressure applied to the lithium-metal electrochemical cell is transferred to the negative electrode of the cell. For example, a lithium-metal electrochemical cell may have a flexible cell enclosure (e.g., a flexible pouch).

### Battery Assembly Examples

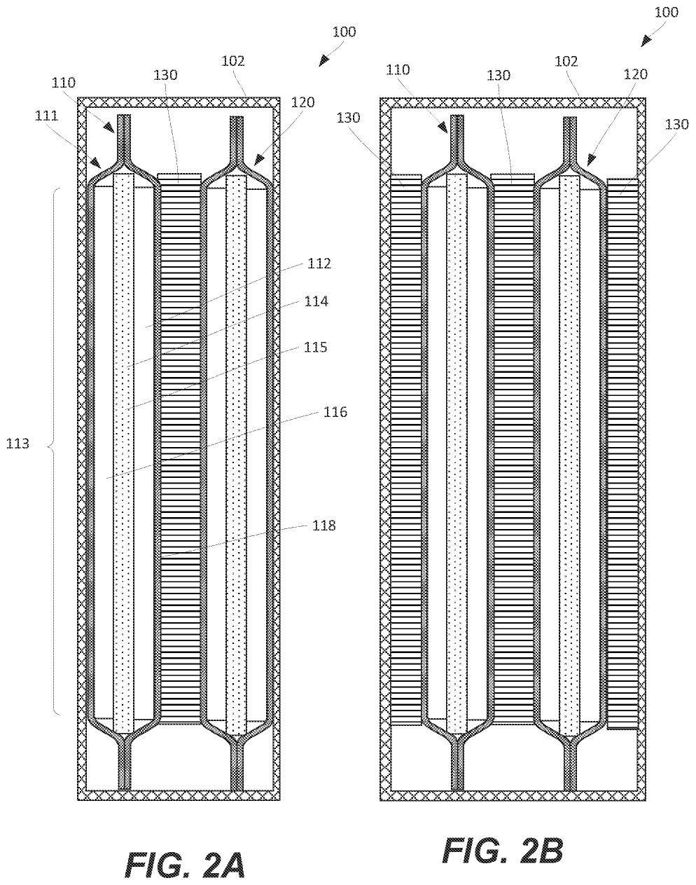

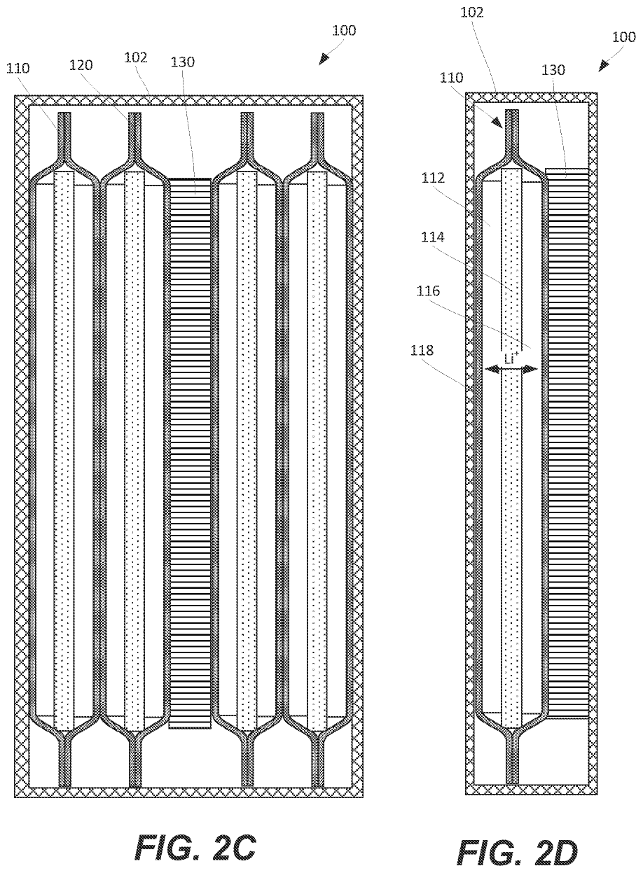

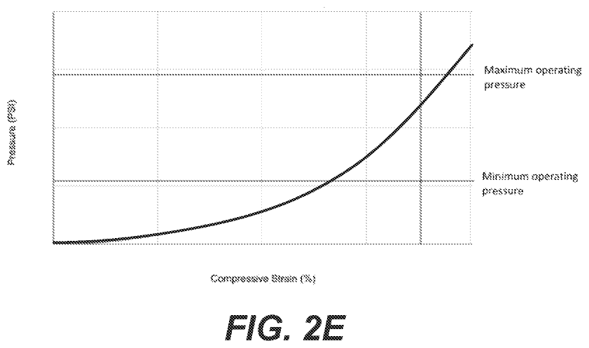

Referring to FIGS. 2A-2D, in some examples, battery assembly 100 comprises lithium-metal electrochemical cell 110 and pressure-applying structure 130. Pressure-applying structure 130 is positioned adjacent to lithium-metal electrochemical cell 110 and applies uniform pressure between a set minimum threshold and a set maximum threshold to lithium-metal electrochemical cell 110. It should be noted that this pressure is applied at any operating SOC of lithium-metal electrochemical cell 110 and, in some examples, over the operating lifetime of the cell. In other words, this pressure is applied between the set minimum and maximum thresholds and accounts for a cumulative effect of the SOH-based swelling and the SOC-based thickness change.

In more specific examples, pressure-applying structure 130 is positioned between a pair of cells, e.g., lithium-metal electrochemical cell 110 and additional lithium-metal electrochemical cell 120 as schematically shown in FIGS. 2A, 2B, and 2C. In these examples, the same pressure-applying structure 130 can apply pressure to multiple cells at the same time, e.g., two cells FIGS. 2A and 2B or four cells in FIG. 2C. Referring to FIG. 2C, in some examples, pressure-applying structure 130 applies pressure onto one or more cells that do not directly interface pressure-applying structure 130. For example, FIG. 2C illustrates lithium-metal electrochemical cell 110 being separated from interface pressure-applying structure 130 by additional lithium-metal electrochemical cell 120 such that additional lithium-metal electrochemical cell 120 is capable of transferring pressure from pressure-applying structure 130 to lithium-metal electrochemical cell 110. In this example, the pressure applied to lithium-metal electrochemical cell 110 is substantially the same as the pressure applied to additional lithium-metal electrochemical cell 120 (e.g., within 10% or even within 20%). This pressure-transfer functionality is provided by the cell's ability to move within battery assembly 100, i.e., being movably supported within battery assembly 100. In some examples, at least some or all of this movable support is provided by the pressure operable on the cell. Using one pressure-applying structure 130 for multiple lithium-metal electrochemical cells helps to reduce the weight and volume of battery assembly 100 for a given capacity.

In some examples, pressure-applying structure 130 is positioned between each pair of adjacent lithium-metal electrochemical cells. For example, pressure-applying structure 130 can be also used to isolate the cells in battery assembly 100 for safety reasons (e.g., to reduce heat transfer and/or stop ejecta from one cell to be transferred to adjacent cells). Furthermore, this example may be used to ensure more uniform pressure application to multiple lithium-metal electrochemical cells, e.g., that all cells experience substantially the same pressure.

Referring to FIGS. 2B and 2D, in some examples, battery assembly 100 further comprises assembly enclosure 102 such that pressure-applying structure 130 is disposed between lithium-metal electrochemical cell 110 and assembly enclosure 102. As such, battery assembly 100 may include only one cell, e.g., as shown in FIG. 2D. Furthermore, positioning pressure-applying structure 130 between assembly enclosure 102 and lithium-metal electrochemical cell 110 helps to redistribute the pressure created during the cell swelling, e.g., exerting uniform pressure on assembly enclosure 102. Furthermore, pressure-applying structure 130 can help with reducing the heat transfer between assembly enclosure 102 and lithium-metal electrochemical cell 110 and/or stop ejecta (released by lithium-metal electrochemical cell 110) from reaching assembly enclosure 102, e.g., during thermal runaway of lithium-metal electrochemical cell 110.

Referring to FIGS. 2A, 2C, and 2D, in some examples, lithium-metal electrochemical cell 110 directly interfaces assembly enclosure 102. Alternatively, multiple pressure-applying structures 130 separate one or more lithium-metal electrochemical cells from assembly enclosure 102, e.g., as shown in FIG. 2B. For example, pressure-applying structures 130 can help to thermally isolate assembly enclosure 102 from the lithium-metal electrochemical cells. Furthermore, pressure-applying structures 130 can be used for lithium-ejecta containment.

As noted above, in some examples, the set minimum threshold, for the pressure applied by pressure-applying structure 130 on lithium-metal electrochemical cell 110, is between 200 kPa and 400 kPa or, more specifically, between 250 kPa and 350 kPa or even between 200 kPa and 400 kPa. Experimental results have demonstrated that lower pressure levels do not produce sufficiently uniform lithium deposition resulting in shorter cycle life.

In some examples, the set maximum threshold, for the pressure applied by pressure-applying structure 130 on lithium-metal electrochemical cell 110, is between 600 kPa and 1,000 kPa or, more specifically, between 700 kPa and 900 kPa or even between 750 kPa and 850 kPa. Larger pressure levels may cause internal shorts and may require special designs of pressure-applying structure 130 and assembly enclosure 102 and are generally not practical.

It should be noted that while pressure-inducing structure 130 applies uniform pressure between a set minimum threshold and a set maximum threshold on lithium-metal electrochemical cell 110, the applied pressure is not constant. The applied pressure can vary between the thresholds (without going outside the limits set by these thresholds) in response to the SOC-based thickness change. Furthermore, the applied pressure can slowly increase (without exceeding the set maximum threshold) in response to the SOH-based swelling. For example, during the initial fabrication of battery assembly 100, pressure-inducing structure 130 can be configured to apply the pressure closer to the minimum threshold. In other words, pressure-inducing structure 130 applies uniform pressure between a set minimum threshold and a set maximum threshold on lithium-metal electrochemical cell 110 at any operating state of charge of lithium-metal electrochemical cell 110. Furthermore, pressure-inducing structure 130 applies uniform pressure between a set minimum threshold and a set maximum threshold on lithium-metal electrochemical cell 110 over an operating lifetime of battery assembly 100. These features are achieved by specific configurations of pressure-applying structure 130 as well as special configurations of battery assembly 100.

In some examples, during the fabrication of battery assembly 100, a stack comprising pressure-inducing structure 130 and lithium-metal electrochemical cell 110 is loaded to an initial pressure at or close to the set minimum threshold. Lithium-metal electrochemical cell 110 can be fully discharged at this stage (e.g., at a minimum thickness). This initial pressure corresponds to the minimal pressure that lithium-metal electrochemical cell 110 will ever experience during its operation. As lithium-metal electrochemical cell 110 starts charging, the thickness of lithium-metal electrochemical cell 110 will increase and so is the pressure applied to lithium-metal electrochemical cell 110. Furthermore, as lithium-metal electrochemical cell 110 continues to cycle, lithium-metal electrochemical cell 110 will swell also resulting in a pressure increase. The difference between the thresholds and the configuration of battery assembly 100 ensures that a cumulative effect of the SOH-based swelling and the SOC-based thickness change is accounted for and the applied pressure never exceeds the maximum threshold. Specifically, pressure-applying structure 130 is configured to have a compression force-deflection response that accounts for the cumulative effect of the SOH-based swelling and the SOC-based thickness change. FIG. 2E is one example of a plot of the pressure exerted by a pressure-applying structure as a function of the compressive strain.

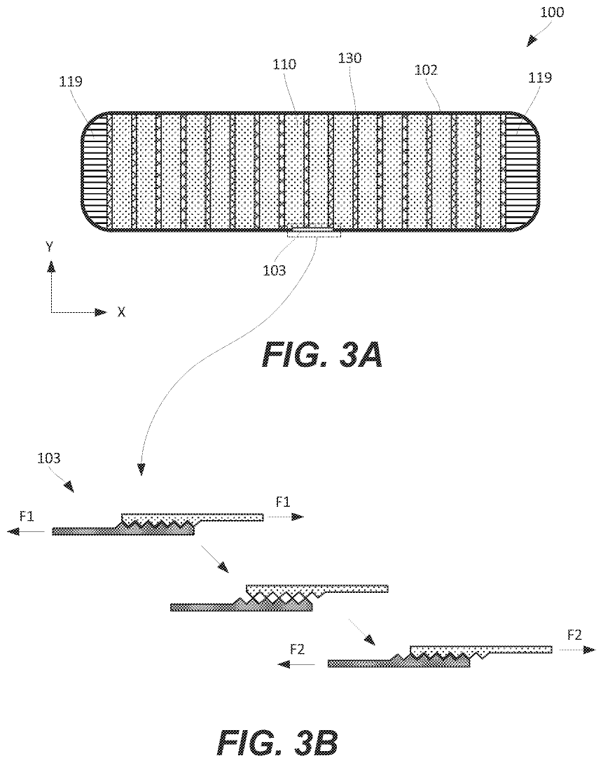

In some examples, battery assembly 100 comprises a component used for constraining the stack comprising pressure-inducing structure 130 and lithium-metal electrochemical cell 110 such that the stack is loaded to the initial pressure. Some examples of this component include, but are not limited to, a band, a battery assembly enclosure, and other like components positioned around pressure-inducing structure 130 and lithium-metal electrochemical cell 110. FIG. 3A is a schematic top view of battery assembly 100, in which assembly enclosure 102 forms a band around lithium-metal electrochemical cells 110. Lithium-metal electrochemical cells 110 are stacked along the X-direction with pressure-inducing structure 130 positioned between each pair of adjacent lithium-metal electrochemical cells 110. Furthermore, additional pressure-inducing structures 130 are positioned at the ends of this stack, e.g., between the end lithium-metal electrochemical cells 110 and end plates 119. In some examples, end plates 119 are used to accommodate the curvature at the ends of enclosure 102. Furthermore, end plates 119 can be also operable as pressure-inducing structures 130, e.g., with different compression characteristics.

In some examples, battery assembly 100 comprises a mechanism of monitoring pressure. If a pressure exceeding the set maximum threshold is detected, the mechanism expands the module chassis to reduce the pressure on lithium-metal electrochemical cell 110. Referring to FIGS. 3A and 3B, assembly enclosure 102 that forms a band around lithium-metal electrochemical cells 110 can comprise pressure-relieving device 103. Comprise pressure-relieving device 103 supports two portions of assembly enclosure 102 allow these portions to move relative to each other at a certain condition. When lithium-metal electrochemical cells 110 swell, these portions experience the tension force caused by the increased pressure acting on lithium-metal electrochemical cells 110. When this tension force exceeds a set threshold (e.g., F1>threshold), the two portions of assembly enclosure 102 move relative to each other (as, e.g., is schematically shown in FIG. 3B) and expand assembly enclosure 102. The expansion of assembly enclosure 102 reduces the pressure acting on lithium-metal electrochemical cells 110 and also reduces this tension force (e.g., F2<threshold) on the two portions of assembly enclosure 102. The process can be repeated as the pressure continues to increase.

In some examples, lithium-metal electrochemical cell 110 comprises electrodes 111 (e.g., positive electrode 112 and negative electrode 116), each having planar portion 113. The footprint of pressure-inducing structure 130 fully covers the footprint of planar portion 113. This feature ensures that the entire planar portion 113 experiences sufficient pressure during the operation of battery assembly 100. It should be noted that both stacked and wound prismatic cells are within the scope. Wound prismatic cells may be equipped with an additional pressure-inducing structure in the non-planar portion (e.g., the turn portion) of the “jellyroll”.

Pressure-inducing structure 130 can be made from one or more materials that provide suitable pressurizing and, in some examples, other properties. For example, at least a portion of pressure-inducing structure 130 can have a stress relaxation of less than 5% or less than 4% or even less than 3%. Stress relaxation corresponds to a decrease in stress in response to the strain, generated in pressure-inducing structure 130. For purposes of this disclosure, stress relaxation is defined as the decay of about 250-300 kPa load after 1 hour at the constant strain tested at 25° C. With such low stress-relaxation values, pressure-inducing structure 130 is able to maintain the set pressure for the operating lifetime of battery module 100, which can be multiple years. This stress relaxation feature ensures that the applied pressure stays above the set minimum threshold over time. Some examples of materials suitable for pressure-inducing structure 130 that can be configured to have the stress relaxation characteristics listed include but are not limited to solid polymers (e.g., polyethylene, polypropylene, polystyrene, polyacrylate, polyurethane, polysiloxanes, neoprenes, polytetrafluoroethylene, poly(methyl methacrylate), polyimide), solid ceramics, in-organic components (e.g., alumina, silica, silicon carbide, silicon nitride, boron carbide, and boron nitride, carbon-containing and carbon-based materials, and carbides), and various combinations thereof (e.g., blends of polymer and in-organics materials).

In some examples, if the material of pressure-inducing structure 130 exhibits the stress relaxation of greater than 5%, then battery assembly 100 may be configured to load the stack of pressure-inducing structure 130 and lithium-metal electrochemical cell 110. In this example, lithium-metal electrochemical cell 110 and pressure-inducing structure 130 are first loaded. The pressure starts reducing (upon experiencing this initial load) as the material of pressure-inducing structure 130 experiences stress relaxation. Battery assembly 100 can be then reloaded to the specified pressure, e.g., after the initial pressure reduction levels off. The stack loading feature ensures that the applied pressure stays above the set minimum threshold over time. Alternatively, the stack may be reloaded multiple times until the relaxation halts. However, in such cases, the compression force-deflection response is recharacterized under representative conditions to ensure that the maximum pressure does not exceed the set maximum threshold.

In some examples, at least a portion of pressure-inducing structure 130 has a compression set of less than 10% or, more specifically, less than 8% or even less than 6%. The compression set is a permanent deformation remaining after the removal of pressure applied to pressure-inducing structure 130. More specifically, this characteristic is defined as the percent deformation following the application of 800-850 kPa for 70 hrs at room temperatures on a sample with dimensions of 30 mm by 30 mm. This characteristic is due to the cyclic swelling and contraction that is imparted on pressure-inducing structure 130 by lithium-metal electrochemical cell 110. If the compression set occurs during charging, then subsequent cycles will fall below this minimum pressure.

In some examples, at least a portion of pressure-inducing structure 130 remains in an elastic deformation region at any state of charge of lithium-metal electrochemical cell 110. In the elastic deformation region, the relationship between stress and strain is generally linear. As such, the pressure applied to lithium-metal electrochemical cell 110 predictably varies between the set minimum threshold and the set maximum threshold while a set minimum threshold and a set maximum threshold changes its thickness during cycling (e.g., as parts of SOC and SOH changes as explained above). This elastic deformation feature also ensures that the applied pressure stays above the set minimum threshold over time. In some examples, to avoid plastic deformation, the yield strength of the material forming pressure-inducing structure 130 is at least 800 kPa, at least 1,000 kPa, or even at least 1,200 kPa.

In some examples, at least a portion of pressure-inducing structure 130 has a thermal conductivity of less than 0.2 W/mK or even less than 0.1 W/mK. Low thermal conductivity helps to reduce heat propagation within battery assembly 100, e.g., during thermal runaway events. Some examples of materials suitable for pressure-inducing structure 130 and capable of providing these thermal conductivity characteristics are listed above. It should be noted that, in some examples, the thermal conductivity of pressure-inducing structure 130 can change as pressure-inducing structure 130 compresses and expands in response to the cell thickness changes. In these examples, the above-referenced thermal conductivity values apply to the most compressed state of pressure-inducing structure 130.

In some examples, pressure-inducing structure 130 has a density of less than 1.5 g/cm³ or, more specifically, less than 1.0 g/cm³ or even less than 0.5 g/cm³ while applying the uniform pressure at the set maximum threshold on lithium-metal electrochemical cell 110. Small density helps to reduce weight penalties in battery assembly 100 since pressure-inducing structure 130 does not contribute to the cell capacity.

In some examples, at least a portion of pressure-inducing structure 130 is foam or aerogel. Both types of structures have low densities, low thermal conductivities, and can be capable of providing other characteristics described above. In more specific examples, pressure-inducing structure 130 has a porosity of at least about 30%, at least about 50%, or even at least about 70%. Alternatively, pressure-inducing structure 130 can be a non-porous structure, e.g., with a porosity of less than 10%, less than 5%, or even less than 2%. For example, the foam of pressure-inducing structure 130 comprises one or more of polyethylene, polypropylene, polystyrene, polyurethane, polysiloxanes, neoprenes, polytetrafluoroethylene, poly(methyl methacrylate), polyacrylate, polyimide, flame-resistant rubber, foam ceramic, in-organic component (e.g., alumina, silica, silicon carbide, silicon nitride, boron carbide, and boron nitride), carbon-containing materials, and carbon-based material. Such ceramic based-foams are often referred to as aerogels, where greater than 90% of the volume of the structure is air. Such ceramic based-foams are often referred to as aerogels, where greater than 90% of the volume of the structure is air. Foams typically have flat compressive force deflection (CFD) curves, remain elastic over a large compression range, have low thermal conductivity, and have very low density. The composition of the solid components of the foams may be a range of polymeric materials that retain desirable mechanical and thermal properties. Aerogels can include high air-fraction ceramics and silica-based materials. These materials share similar properties to foams, such as low density and thermal conductivity. Furthermore, these materials have tunable mechanical properties and compression force responses. In some examples, pressure-inducing structure 130 comprises carbon-fiber-reinforced polymers or carbon-containing composites, which can have tunable mechanical properties and highly desirable thermal properties. Furthermore, carbon-containing composites and carbon-based materials are resistant to molten lithium. As such, pressure-inducing structure 130 can be also operable as a lithium-ejecta containment component.

In some examples, at least a portion of pressure-inducing structure 130 comprises a material with a temperature resistance of at least 1500° C. or, more specifically at least 1750° C. or even at least about 2000° C. Various carbon-based materials (e.g., graphite, carbon fiber reinforced polymers) and ceramics (e.g., aluminum oxide, silicon carbide, silicon nitride, boron carbide, and boron nitride) are within the scope. This temperature resistance can be used to mitigate lithium fires in battery assembly 100. For example, molten lithium metal can burn at temperatures of 1200° C. or more. At the same time, aluminum oxide has a melting point of 2072° C., while silicon carbide has a melting temperature of 2730° C.

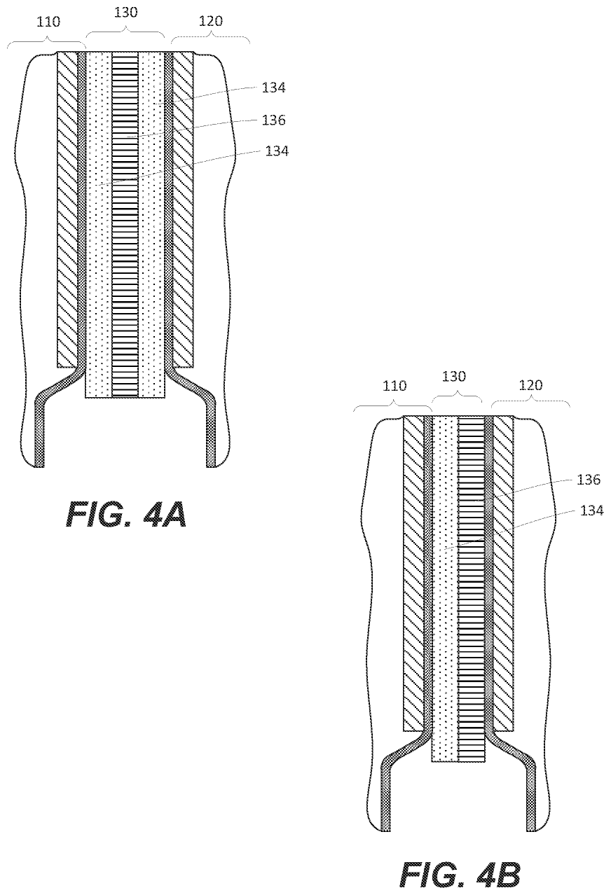

Referring to FIGS. 4A and 4B, in some examples, pressure-inducing structure 130 is a composite structure comprising heat-blocking component 134 and pressurizing component 136. This approach allows separating two functions between these components. For example, heat-blocking component 134 can have a thermal conductivity of less than 0.2 W/mK or even less than 0.1 W/mK. At the same time, pressurizing component 136 remains in an elastic deformation region at any state of charge of either lithium-metal electrochemical cell 110 or additional lithium-metal electrochemical cell 120. For example, FIG. 4A illustrates an example of pressure-inducing structure 130 in which pressurizing component 136 (e.g., foam or aerogel) is positioned between two heat-blocking components 134 (e.g., carbon-based materials and ceramics). FIG. 4B illustrates an example of pressure-inducing structure 130 in which pressurizing component 136 next to a single layer of heat-blocking components 134.

As noted above and with reference to FIG. 2A, lithium-metal electrochemical cell 110 comprises positive electrode 112, negative electrode 116, and separator 114 disposed between positive electrode 112 and negative electrode 116. Separator 114 allows the ionic transfer and provides the electronic insulation between positive electrode 112 and negative electrode 116. Separator 114 can be a solid-state separator, which may be also referred to as a solid-state electrolyte, effectively integrating the two functions in the same material. Some examples of suitable solid-state electrolytes for use with lithium-metal electrochemical cells include, but are not limited to, inorganic electrolytes, organic electrolytes, and composite electrolytes. Some examples of inorganic electrolytes include, but are not limited to, lithium superionic conductor (LISICON), argyrodite-like components, garnets (e.g., lithium lanthanum zirconium oxide), lithium nitrides (Li₃N), lithium hydrides (LiBH₄), lithium lanthanum titanate, lithium halides, lithium phosphorus oxynitride (LIPON), and lithium thiophosphate. Some examples of organic electrolytes include, but are not limited to, polyether-based electrolytes (e.g., polyethylene oxide-based ones), polycarbonate-based electrolytes, polyester-based electrolytes, polynitrile-based electrolytes, polyalcohol-based electrolytes, polyamine-based electrolytes, polysiloxane-based electrolytes, fluoropolymer-based electrolytes, and bio-polymer-based electrolytes. In other examples, lithium-metal electrochemical cell 110 also comprises liquid electrolyte 115. Liquid electrolyte 115 soaks separator 114 and provides the ionic transfer. Some examples of liquid electrolyte 115 include, but are not limited to, a mixture of one or more lithium-containing salts and one or more solvents. Some examples of lithium-containing salts include, but are not limited to, lithium bis(fluorosulfonyl)imide (LiFSI), lithium bis(trifluoromethylsulfonyl)amide (UTFSI), lithium tetrafluoroborate (LiBF₄), lithium hexafluorophosphate (LiPF₆), lithium bis(oxalato)borate (LiBOB), lithium difluoro(oxalato)borate (LiDFOB), lithium trifluoromethanesulfonate (LiTf), lithium nitrate (LiNO₃), and various combinations thereof. More preferably, the lithium salt is LiFSI or LiTFSI, and most preferably LiFSI. Some examples of electrolyte solvents but are not limited to, one or more cyclic ethers (e.g., 1,3-dioxane (DOL), 1,4-dioxane (DX), tetrahydrofuran (THF)), one or more linear ethers (e.g., dimethoxyethane (DME), Bis(2-methoxyethyl) ether (G2), triethylene glycol dimethyl ether (G3), or tetraethylene glycol dimethyl ether (G4), Bis(2,2,2-trifluoroethyl)ether (BTFE); ethylal; 1,1,2,2-tetrafluoroethyl 2,2,3,3-tetrafluoropropyl ether (TFPE)), and combination thereof. Additional liquid-electrolyte components may include, but not limited to, metal salts (e.g., having bis(trifluoromethanesulfonyl)imide (TFSI), bis(fluorosulfonyl)imide (FSI), hexafluorophosphate (PF₆), tetrafluoroborate (BF₄), and/or bis(oxalate)borate (BOB) anions), ionic liquids (eg., propyl-methyl-pyrrolidinium-FSI/TFSI; butyl-methyl-pyrrolidinium-FSI/TFSI; octyl-methyl-pyrrolidinium-FSI/TFSI, and any combination thereof), and the like.

Positive electrode 112 can include a current collector (e.g., an aluminum foil) and an active material layer comprising an active material (e.g., in a form of particles) and a binder (e.g., a polymer binder). Some examples of positive active materials include, but are not limited to, lithium nickel manganese cobalt (NMC) oxides, lithium iron phosphate, and the like. Some examples of suitable binders include, but are not limited to, polymer binders (e.g., polyvinylidene-fluoride (PVDF), styrene butadiene rubber (SBR), and carboxyl methyl cellulose (CMC)). In some examples, positive electrode 112 comprises a conductive additive (e.g., carbon black/paracrystalline carbon).

Negative electrode 116 can also include a current collector on which a lithium metal layer is deposited when lithium-metal electrochemical cell 110 is charged. Some examples of suitable current collectors include, but are not limited to, copper, nickel, aluminum, stainless steel, a metalized polymer substrate (e.g., metalized with copper), a carbon-coated metal substrate. The purpose of using a negative electrode with a lithium-metal layer deposited on a current collector (in lithium-metal electrochemical cells) is to reduce the size of the negative electrode (e.g., in comparison to lithium-ion cells). For example, the thickness of the lithium-metal layer can be less than 20 micrometers. Furthermore, the addition of a current collector also helps to keep the thickness of the lithium-metal layer small. For example, the thicknesses of less than 20 micrometers are difficult to achieve with a freestanding lithium foil. As such, lithium-metal cells with negative electrodes formed by freestanding lithium foils/layers require substantially more lithium than lithium-metal cells with negative electrodes formed by a combination of a current collector and a lithium-metal layer (to achieve the same cell capacity). Lower amounts of lithium are highly desirable from the safety perspective as less lithium ejecta (e.g., molten lithium ejecta) needs to be contained when the cell goes into the thermal runaway.

Positive electrode 112, negative electrode 116, and separator 114 can be referred to as internal components of lithium-metal electrochemical cell 110. These internal components are sensitive to moisture and other ambient conditions and insulated from the environment by cell enclosure 118. In some examples, cell enclosure 118 is formed from aluminum (e.g., for cylindrical or prismatic cells), a pouch laminate, an aluminum-coated polymer (e.g., polyamide, polyester, polyurethane, and polypropylene).

### Application Examples

Battery assembly 100 comprising lithium-metal electrochemical cells and pressure-applying structure 130 can be used for various applications, such as ground-based vehicles, boats, aircraft, and spacecraft. For example, aircraft and/or spacecraft use Li-metal batteries as such batteries have significantly higher gravimetric energy density than, e.g., Li-ion batteries. Both aircraft and spacecraft applications require lower mass cells, as additional mass leads to lower payload capacity. For these applications to utilize the maximum amount of their designed capacity, the energy system must be the lowest mass possible. In addition, safety and continuous operation are paramount in both of these applications.

Li-metal batteries offer electric aircraft a larger payload-range capability, greatly expanding market appeal. For example, aviation regulatory authorities (e.g., FAA in the US and EASA in Europe) have strict requirements for battery safety and continuity. Battery assemblies 100, described herein, provide improvement in energy density and safety, when compared to most-advanced Li-ion batteries. For example, Li-metal batteries provide high energy density allowing these batteries or, more specifically, battery assemblies comprising Li-metal batteries to be deployed in various aircraft-related applications, e.g., unmanned aircraft systems (UAS) with longer flight times and to have substantially reduced risk of fire or in-flight break-up compared to current Li-ion batteries.

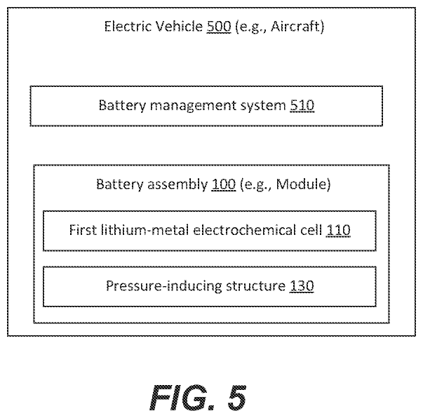

FIG. 5 is a block diagram of electric vehicle 500 (e.g., aircraft, spacecraft) comprising battery assembly 100, which in turn comprises first lithium-metal electrochemical cell 110, and pressure-applying structure 130. Electric vehicle 500 also comprises battery management system 510, electrically and communicatively coupled to battery assembly 100. For example, battery management system 510 can receive various operating signals from battery assembly 100, such as state of charge, pressure, temperature, voltage, current, and the like. Battery management system 510 can detect when the external pressure goes outside the range set by the minimum and maximum pressure threshold and, if needed, electrically disconnect the unsafe cell and/or activate corresponding systems.

### Experimental Results

A set of tests was conducted to determine the effect of adding pressure-applying structures into battery assemblies. Each tested battery assembly included a lithium-metal cell and a pressure-applying structure. However, different pressure levels were applied to the lithium-metal cells of different battery assemblies. These pressure levels varied from 200 kPa to about 825 kPa. One reference cell was used without any pressure applied to the cell (i.e., 0 kPa applied to the cell). All tests were cycled for 275-300 cycles to determine the capacity retention. Cycling was performed at a 0.5C constant current charge rate to 4.28V, with a constant voltage limit to a C/6 current cut-off, and a 1C constant current discharge. The results are presented in FIG. 6A.

The capacity retention after 250 cycles was 81.56% at 0 kPa, 85.53% at 200 kPa, 88.14% at 275 kPa, 90.24% at 550 kPa, and 91.8% at 825 kPa. It should be noted that the capacity retention rapidly drops below 275 kPa, e.g., to 85.53% at 200 kPa and 81.56% at 0 kPa. As such, pressurizing lithium-metal cells below 200 kPa does not provide major benefits. On the other hand, pressure levels above 825 kPa require special components and systems to support these pressure levels while the benefits of increasing the pressure above 825 kPa appear to be minimal. For example, the capacity retention improved only by 1.6% when the pressure was increased from 550 kPa to 825 kPa. Furthermore, as noted above, higher pressure levels increase the propensity for internal shorts. As shown in FIG. 6A, the cell experiencing 825 kPa pressure experienced an internal short after about 280 cycles.

Additional test results (in the form of cycling data) are shown in FIG. 6B. In this experiment, all cells were cycled at a 0.5C constant current charge rate to 4.28V, with a constant voltage limit to a C/6 current cut-off, and a 1C constant current discharge. All sells were loaded to 275 kPa at 30% SOC in constant volume fixtures with 20 mm of foam polysiloxane, 6.35 mm of solid (non-porous) polysiloxane, and 4.5 mm of aerogel material. Due to the stress relaxation >5% of the foam polysiloxane and the compression set >10% of the aerogel, these materials lead to worse capacity retention compared to the solid (non-porous) polysiloxane.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

1. A battery assembly comprising:
a lithium-metal electrochemical cell comprising a liquid electrolyte; and
a pressure-applying structure, positioned adjacent to the lithium-metal electrochemical cell and applying uniform pressure between a set minimum threshold and a set maximum threshold to the lithium-metal electrochemical cell at any operating state of charge of the lithium-metal electrochemical cell.

2. The battery assembly of claim 1, further comprising an additional lithium-metal electrochemical cell, wherein the pressure-applying structure is disposed between the lithium-metal electrochemical cell and the additional lithium-metal electrochemical cell and applies the uniform pressure to the lithium-metal electrochemical cell and to the additional lithium-metal electrochemical cell.

3. The battery assembly of claim 1, further comprising an assembly enclosure, wherein the pressure-applying structure is disposed between the lithium-metal electrochemical cell and the assembly enclosure.

4. The battery assembly of claim 1, wherein the set minimum threshold is between 200 kPa and 400 kPa.

5. The battery assembly of claim 1, wherein the set maximum threshold is between 600 kPa and 1,000 kPa.

6. The battery assembly of claim 1, wherein the lithium-metal electrochemical cell is a pouch cell or a prismatic cell.

7. The battery assembly of claim 1, wherein:
the lithium-metal electrochemical cell comprises electrodes, each having a planar portion, and
a footprint of the pressure-inducing structure fully covers a footprint of the planar portion.

8. The battery assembly of claim 1, wherein the pressure-inducing structure directly interfaces the lithium-metal electrochemical cell.

9. The battery assembly of claim 1, wherein at least a portion of the pressure-inducing structure remains in an elastic deformation region at any state of charge of the lithium-metal electrochemical cell.

10. The battery assembly of claim 1, wherein at least a portion of the pressure-inducing structure has a thermal conductivity of less than 0.2 W/mK.

11. The battery assembly of claim 1, wherein the pressure-inducing structure has a density of less than 1.5 g cm³ while applying the uniform pressure at the set maximum threshold on the lithium-metal electrochemical cell.

12. The battery assembly of claim 1, wherein at least a portion of the pressure-inducing structure is foam or aerogel.

13. The battery assembly of claim 15, wherein the foam of the pressure-inducing structure comprises one or more of polyethylene, polypropylene, polystyrene, polyurethane, polysiloxane, neoprene, polytetrafluoroethylene, poly(methyl methacrylate), polyacrylate, polyimide, flame-resistant rubber, and foam ceramic.

14. The battery assembly of claim 15, wherein the pressure-inducing structure comprises a non-porous polysiloxane.

15. The battery assembly of claim 15, wherein the pressure-inducing structure has a porosity of less than 10%.

16. The battery assembly of claim 15, wherein the pressure-inducing structure comprises one or a carbon-containing composite and a carbon-based material.

17. The battery assembly of claim 15, wherein the pressure-inducing structure comprises a carbon-fiber-reinforced polymer.

18. The battery assembly of claim 1, wherein at least a portion of the pressure-inducing structure comprises a material with a temperature resistance of at least 2000° C.

19. The battery assembly of claim 1, wherein:
the pressure-inducing structure is a composite structure comprising a heat-blocking component and a pressurizing component,
the heat-blocking component has a thermal conductivity of less than 0.2 W/mK, and
the pressurizing component remains in an elastic deformation region at any state of charge of either the lithium-metal electrochemical cell or the additional lithium-metal electrochemical cell.

20. The battery assembly of claim 1, wherein the pressure-inducing structure applies the uniform pressure between the set minimum threshold and the set minimum threshold on the lithium-metal electrochemical cell over an operating lifetime of the battery assembly.
